(19) United States
(12) Patent Application Publication
(10) Pub. No.: US 2009/0310997 A1
(43) Pub. Date: Dec. 17, 2009

(54) IMAGE FORMING APPARATUS WHICH PRESENTS PATTERN AND METHOD THEREOF

(75) Inventors: Son-young LEE, Seoul (KR); Ji-sang PARK, Yongin-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/327,183

(22) Filed: Dec. 3, 2008

(30) Foreign Application Priority Data
Jun. 11, 2008 (KR) 2008-54629

(51) Int. Cl. G03G 15/20

(52) U.S. Cl. 399/70

(57) ABSTRACT

An image forming apparatus which displays a preset pattern is provided, including a fixing unit, and a cover unit which is mounted on a main body in which the fixing unit is installed, and displays the preset pattern if the cover unit is heated by the fixing unit. Accordingly, the heating state of the image forming apparatus can be visually shown to users. In addition, diverse type of patterns can be applied so that an effective design can be provided.

### CROSS-REFERENCE TO RELATED APPLICATION

This application claims the benefit of Korean Application No. 2008-54629, filed Jun. 11, 2008, in the Korean Intellectual Property Office, the disclosure of which is incorporated herein by reference.

### BACKGROUND OF THE INVENTION

1. Field of the Invention

Aspects of the present invention relate to an image forming apparatus which displays a pattern and a method thereof, and more particularly, to an image forming apparatus which displays a different preset pattern according to the operating state and a method thereof.

2. Description of the Related Art

Image forming apparatuses print images corresponding to input image data onto a recording medium such as paper, and include printers, photocopiers, and facsimile machines.

In general, image forming apparatuses transfer color or mono images corresponding to image data onto paper, and the images are then fixed onto the paper by a fixing unit and discharged externally.

Since the fixing unit applies high heat and pressure to the paper onto which the image is transferred, the internal temperature of the image forming apparatus increases up to 50° C. to 60° C. However, there are no external changes to the image forming apparatus and thus a user may not be aware of the high temperature and may get burned when touching a cover of the image forming apparatus when fixing a paper jam or picking up the printed paper.

A warning sticker may be used to warn that the user may get burned when the fixing unit is heated, but it is difficult to determine the temperature of the image forming apparatus and such a system is not visibly efficient.

Therefore, there is a need for the image forming apparatus to have a different appearance according to the operation state.

### SUMMARY OF THE INVENTION

Aspects of the present invention provide an image forming apparatus which displays a different preset pattern according to the operation state and a method thereof.

According to an embodiment of aspects of the present invention, there is provided an image forming apparatus including a fixing unit, and a cover unit which is mounted on a main body in which the fixing unit is installed, and displays a preset pattern if the cover unit is heated by the fixing unit.

According to aspects of the present invention, the color intensity of the pattern may vary according to an internal temperature of the main body due to heating of the fixing unit.

According to aspects of the present invention, the cover unit may be formed using a thermochromic resin formed in a shape corresponding to the pattern on an acrylonitrile butadiene styrene (ABS) resin using double injection molding.

According to aspects of the present invention, the pattern may be formed on the cover unit using a thermochromic colorant.

According to aspects of the present invention, the pattern may be at least one of an image and text.

According to aspects of the present invention, the cover unit may be replaceable.

According to aspects of the present invention, the cover unit may include a pattern unit which displays the preset pattern, and the pattern unit can be replaced with a pattern unit which has a same pattern as the preset pattern or a pattern unit which has a different pattern from the preset pattern.

According to another embodiment of aspects of the present invention, there is provided a method for displaying a pattern according to the temperature of an image forming apparatus which includes a main body having a fixing unit and a cover unit covering the main body, the method including receiving a command to print data, warming up the fixing unit according to the received command, and outputting the data, wherein if the fixing unit is heated by the warming-up operation, a preset pattern is displayed on a pattern unit of the cover unit.

According to aspects of the present invention, the color intensity of the pattern may vary according to an internal temperature of the main body due to heating of the fixing unit.

According to aspects of the present invention, the pattern unit may be formed using a thermochromic resin formed in a shape corresponding to the pattern on an acrylonitrile butadiene styrene (ABS) resin using double injection molding.

According to aspects of the present invention, the pattern may be formed on the cover unit using a thermochromic colorant.

According to aspects of the present invention, the pattern may be at least one of an image and text.

According to aspects of the present invention, the cover unit may be replaceable.

According to aspects of the present invention, the pattern unit can be replaced with a pattern unit which has a same pattern as the preset pattern or a pattern unit which has a different pattern from the preset pattern.

According to aspects of the present invention, there is provided a method of displaying the temperature of a printing apparatus, comprising activating a printing apparatus to print data; indicating an amount of heat radiating from the printing apparatus; and changing the indicating the amount of heat radiating from the printing apparatus corresponding to the changing amounts of heat radiating from the printing apparatus.

According to aspects of the present invention, the heat indication unit may be a thermochromic resin; a thermochromic resin formed in a pattern on an acrylonitrile butadiene styrene (ABS) resin; at least one light emitting diode; an analog thermometer; a digital display; a light bulb; and, wherein the heat indication unit is replaceable.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1 and 2 illustrate the interior and exterior of a general image forming apparatus;

FIGS. 3 and 4 illustrate a cover unit according to an embodiment of the present invention;

FIGS. 5A and 5B illustrate a pattern on the cover unit of the image forming apparatus when in standby mode according to an embodiment of the present invention;

FIGS. 6A and 6B illustrate a pattern on the cover unit of the image forming apparatus when in preheating mode according to an embodiment of the present invention;

FIGS. 7A and 7B illustrate a pattern on the cover unit of the image forming apparatus when the image forming apparatus discharges printed paper according to an embodiment of the present invention; and

FIG. 8 is a flow chart illustrating a method for displaying a pattern according to the temperature of the image forming apparatus according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

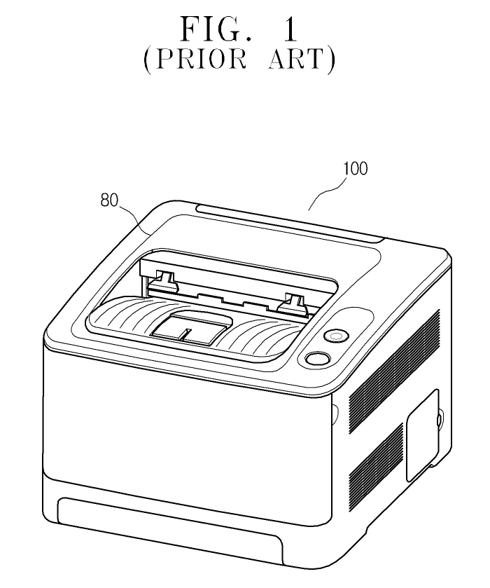

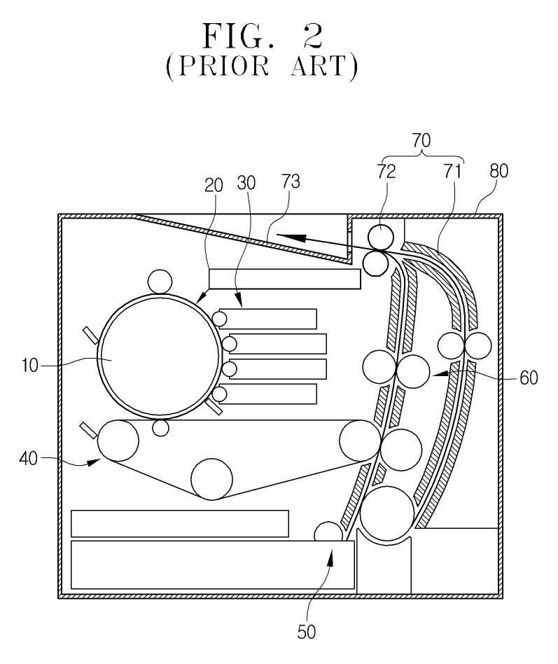

FIGS. 1 and 2 illustrate the interior and exterior of a general image forming apparatus. In greater detail, FIG. 2 illustrates a schematic structure of a color laser printer as an example of a general image forming apparatus 100.

As illustrated, the color laser printer includes a photoconductive drum 10, a laser scanning unit 20 which forms an electrostatic latent image by scanning a laser beam onto the photoconductive drum 10, a developing unit 30 which develops the electrostatic latent image on the photoconductive drum 10 using a toner, a transfer unit 40 which transfers a toner image on the photoconductive drum 10 onto paper, a paper feeding unit 50 which supplies the paper to the transfer unit 40, a fixing unit 60 which fixes the transferred toner image onto the paper, a paper discharge unit 70 which discharges a printed paper to a paper discharge tray 73, and a cover unit 80 which covers a printer body containing the above components.

An electrostatic latent image is formed on the photoconductive drum 10 using a laser beam scanned by the laser scanning unit 20, and is developed by the developing unit 30 as a visible image using the toner. The visible toner image on the photoconductive drum 10 is transferred onto paper supplied from the paper feeding unit 50 by the transfer unit 40, and fixed onto the paper by the fixing unit 60. By this process, printing is performed.

The paper discharge unit 70 includes a paper guide frame 71 and a paper discharge roller 72 which is formed on the paper guide frame 71. The paper discharge unit 70 discharges the printed paper which has passed through the fixing unit 60 to the paper discharge tray 73.

The cover unit 80 forms the exterior of the color laser printer 100. In this embodiment of the present invention, a paper jam cover is illustrated as a part of the cover unit 80. Under the paper jam cover, the paper discharge unit 70 is formed. The paper jam cover is hinged on the printer body.

As the printing speed of the color laser printer gets faster, the temperature of the fixing unit 60 gets higher so as to increase the fixing speed. Accordingly, the fixing unit 60 emits a high amount of radiant heat which is transmitted to the paper discharge unit 70 and the cover unit 80 thereon.

As illustrated in FIG. 2, the image forming apparatus 100, according to an embodiment of the present invention, has a basic structure including the photoconductive drum 10, the laser scanning unit 20, the developing unit 30, the transfer unit 40, the paper feeding unit 50, the fixing unit 60, the paper discharge unit 70, and the cover unit 80, and performs the same operations as the general image forming apparatus described above. However, since a technical feature of an aspect of the present invention is in the cover unit 80, the cover unit 80 is described below in greater detail.

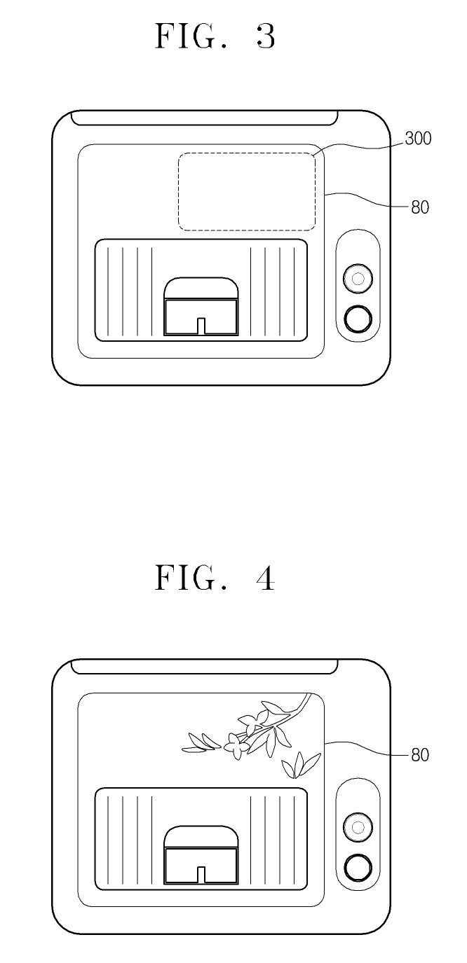

FIGS. 3 and 4 illustrate a cover unit according to an embodiment of the present invention. The cover unit 80 displays a preset pattern according to the internal temperature, which varies due to the radiant heat, allowing the user to recognize the amount of heat corresponding to the current printer state. FIG. 3 illustrates the pattern unit 300 when the image forming apparatus 100 is not in operation, and FIG. 4 illustrate the preset pattern displayed on a pattern unit 300 of the cover unit 80 when the image forming apparatus is operating. Additionally, the temperature of the image forming apparatus 100 resulting from radiant heat can be conveyed to a user of the image forming apparatus 100 by using a heat indicating unit. The heat indicating unity may be: a thermochromic resin; a thermochromic resin formed in a pattern on an acrylonitrile butadiene styrene (ABS) resin; at least one light emitting diode; an analog thermometer; a digital display; a light bulb; and may be replaceable.

The cover unit 80 may be fabricated with a thermochromic resin formed in a shape corresponding to the pattern on a general acrylonitrile butadiene styrene (ABS) resin using double injection molding. The ABS resin is a styrene resin that consists of the three components styrene, acrylonitrile, and butadiene, and is generally easy to process, crashproof, and thermostable, so ABS resin can be used for car components, helmets, electronic components, and spinning machine components instead of metal.

A thermochromic resin is a material that changes color according to the temperature, and uses a thermochromic colorant which coats and encapsulates a pigment. The temperature at which color change occurs can be set within a wide range when developing the resin. Within the set temperature range, color changes can be reversed and colors can be freely selected by a manufacturer.

Alternatively, the pattern can be formed using a thermochromic colorant forming a preset pattern on the cover unit 80, which is formed using the ABS resin. The thermochromic colorant is the same colorant as the thermochromic resin, and the color varies according to the temperature.

As illustrated in FIG. 3, if the image forming apparatus 100 is not in operation and the internal temperature is lower than a set temperature range of the colorant, the thermochromic resin has the same color as the ABS. As illustrated in FIG. 4, if the image forming apparatus 100 is operating, and thereby the internal temperature is within the set temperature range of the colorant, the thermochromic resin absorbs heat generated by the fixing unit 60 such that the color intensity is lighter and thus diminished. Consequently, the pattern is displayed on the pattern unit 300 of the cover unit 80 where the thermochromic resin is molded.

The pattern may take the form of diverse images or text in order to satisfy the user's demands. The pattern may be images, text or both images and text combined. The cover unit 80 may be replaceable. Alternatively, only the portion of the cover unit 80 where the pattern is displayed, that is a pattern unit 300, may be replaceable.

In this embodiment of aspects of the present invention, a paper jam cover is used as the cover unit 80 corresponding to the fixing unit 60, but this is merely an example. The cover unit 80 and the pattern unit 300 can be manufactured so that a pattern is displayed in a certain area of the cover unit 80 heated by a different component which generates heat in the image forming apparatus 100. That is, a pattern may be displayed on a side, front, back or another area of the image forming apparatus 100.

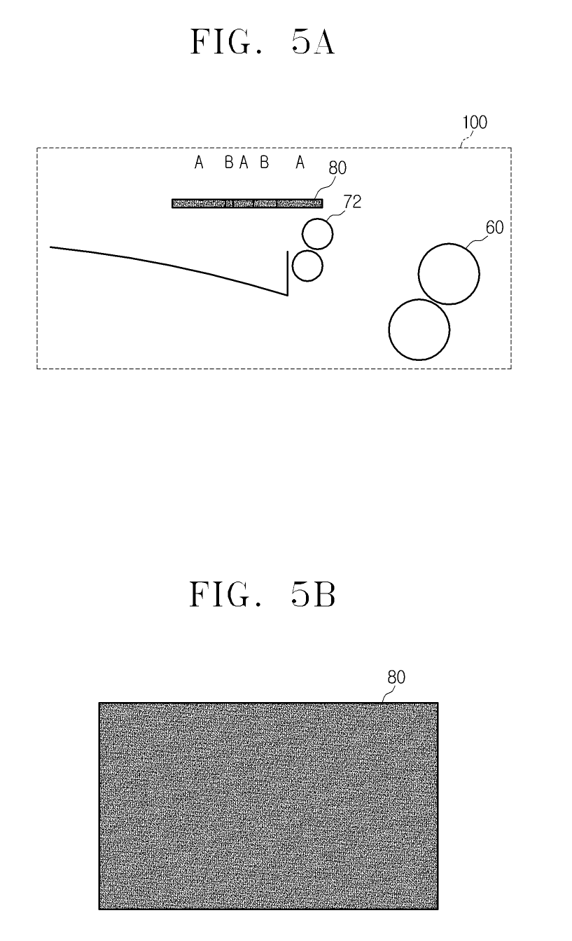

FIGS. 5A to 7B illustrate the showing of a pattern on the cover unit 80 according to the operating state of the image forming apparatus 100. The temperature range in which the color of the colorant changes is set to be from 30° C. to 45° C.

In greater detail, FIG. 5A illustrates a pattern on the cover unit 80 on the image forming apparatus 100 in a standby mode. FIG. 5B is an enlarged view of the cover unit 80 from a perspective above the cover unit 80 when the image forming apparatus is in the standby mode. In the standby mode, the image forming apparatus 100 may be in standby for operation or may be turned off. In such a case, since heat is not generated, the internal temperature remains at room temperature and thus the general ABS resin A and the thermochromic resin B are the same color.

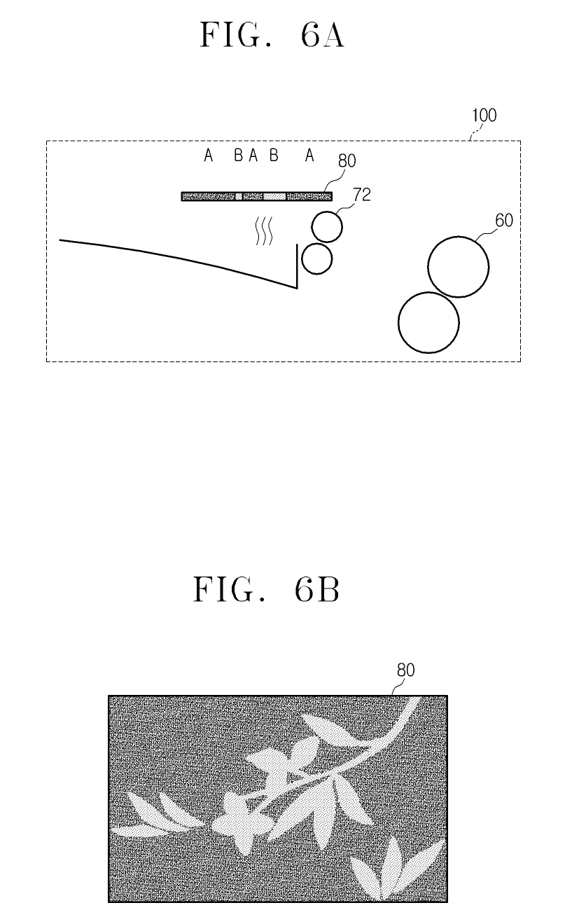

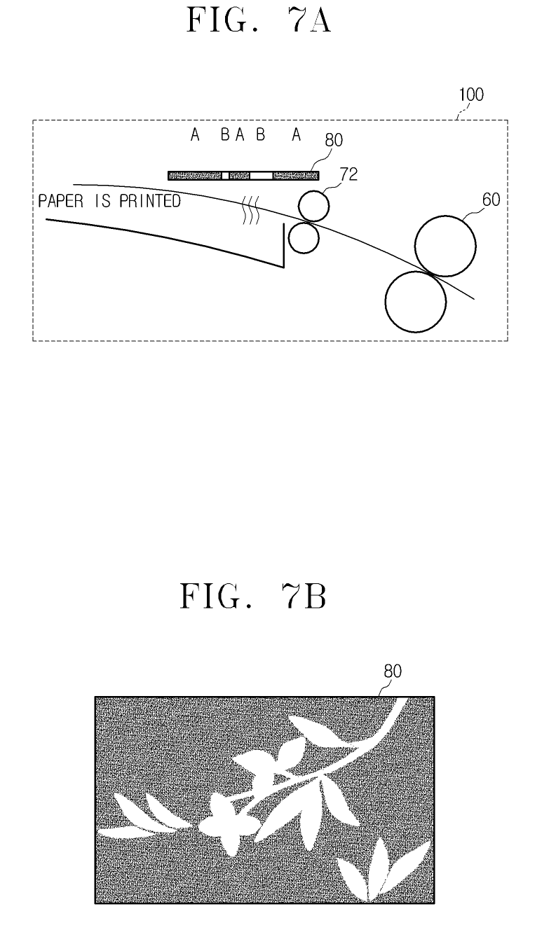

FIG. 6A illustrates a pattern on the cover unit 80 of the image forming apparatus 100 in a preheating mode. FIG. 6B is an enlarged view of the cover unit 80 from a perspective above the cover unit 80 when the image forming apparatus is in the preheating mode. When print data are input to the image forming apparatus 100, each of the components are preheated to perform a corresponding operation. If the internal temperature of the image forming apparatus 100 increases to 35° C., the internal temperature enters the temperature range for the color of the colorant to change such that the color intensity of the thermochromic resin B becomes lighter. Consequently, the pattern is displayed on the cover unit 80.

FIG. 7A illustrates a pattern on the cover unit 80 of the image forming apparatus 100 when the image forming apparatus 100 discharges printed paper. FIG. 7B is an enlarged view of the cover unit 80 from a perspective above the cover unit 80 when the image forming apparatus discharges printed paper. When printed paper is discharged, the internal temperature of the image forming apparatus 100 peaks due to the radiant heat generated by the fixing unit 60. Accordingly, the color intensity of the thermochromic resin is reduced and thus can be clearly differentiated from the color of the general ABS resin so that the pattern is displayed with more contrast. Therefore, by representing the heating state of the image forming apparatus 100 using a diverse range of patterns, the heating state of the image forming apparatus 100 is apparent to the user.

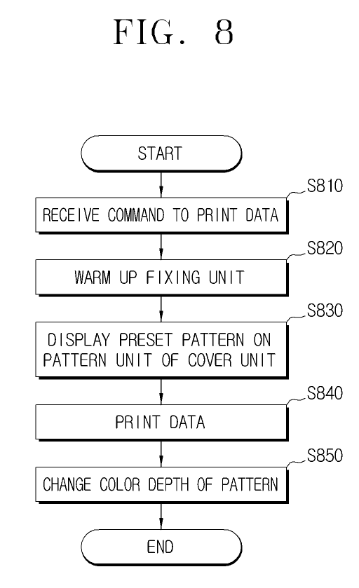

FIG. 8 is a flow chart illustrating a method for displaying a pattern according to the temperature of the image forming apparatus 100 according to an embodiment of the present invention. As illustrated in FIG. 7A, the image forming apparatus 100 includes a main body in which the fixing unit 60 is mounted, and the cover unit 80 which covers the main body. The cover unit 80 includes the pattern unit 300 which is formed to correspond to the fixing unit 60.

As illustrated in FIG. 8, when the image forming apparatus 100 receives a command to print data (S810), the fixing unit 60 warms up (S820) and heat is generated heat such that a preset pattern is displayed on the pattern unit 300 of the cover unit 80 (S830).

The pattern unit 300 may be fabricated with a thermochromic resin formed in a shape corresponding to the pattern on a general ABS resin using double injection molding. The cover unit 80 may be formed of a general ABS resin.

Alternatively, the pattern unit 300 may be formed using a thermochromic colorant forming a preset pattern on the cover unit 80, which is formed using the ABS resin.

If the internal temperature of the image forming apparatus 100 enters the set temperature range of color change for the colorant due to the warm-up operation, the thermochromic resin absorbs heat generated in the fixing unit 60 and the color intensity becomes lighter. Therefore, the pattern is displayed on the pattern unit 300 on which the thermochromic resin is molded.

After the warm-up (S820), if the received data are printed (S840), the color intensity of the pattern unit 300 changes and is reduced (S850). Accordingly, the preset pattern displayed when received data are printed is more distinct than the preset pattern when displayed in warm-up mode. If the image forming apparatus 100 does not receive print commands, the internal temperature falls and thus the thermochromic resin of the pattern unit 300 returns to its original color. Therefore, the pattern disappears.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An image forming apparatus, comprising:
a fixing unit; and
a cover unit which is mounted on a main body in which the fixing unit is installed, and displays a preset pattern if the cover unit is heated by the fixing unit.

2. The apparatus according to claim 1, wherein a color intensity of the preset pattern varies according to an internal temperature of the main body due to heating of the fixing unit.

3. The apparatus according to claim 1, wherein the cover unit is formed using a thermochromic resin formed in a shape corresponding to the preset pattern on an acrylonitrile butadiene styrene (ABS) resin using double injection molding.

4. The apparatus according to claim 1, wherein the preset pattern is formed on the cover unit using a thermochromic colorant.

5. The apparatus according to claim 1, wherein the preset pattern is at least one of an image and a text.

6. The apparatus according to claim 1, wherein the cover unit is replaceable.

7. The apparatus according to claim 5, wherein the cover unit comprises a pattern unit which displays the preset pattern, and the pattern unit is replaceable with a pattern unit which has a same pattern as the preset pattern or a pattern unit which has a different pattern from the preset pattern.

8. A method for displaying a pattern according to the temperature of an image forming apparatus which comprises a main body having a fixing unit and a cover unit covering the main body, the method comprising:
receiving a command to print data;
warming up the fixing unit according to the received command; and
outputting the data,
wherein if the fixing unit is heated by the warming-up operation, displaying a preset pattern on a pattern unit of the cover unit.

9. The method according to claim 8, wherein a color intensity of the preset pattern varies according to an internal temperature of the main body due to heating of the fixing unit.

10. The method according to claim 8, further comprising forming the preset pattern unit in a shape using a thermochromic resin formed on an acrylonitrile butadiene styrene (ABS) resin.

11. The method according to claim 8, wherein the preset pattern is formed on the cover unit using a thermochromic colorant.

12. The method according to claim 8, wherein the preset pattern is at least one of an image and a text.

13. The method according to claim 8, wherein the cover unit is replaceable.

14. The method according to claim 12, wherein the pattern unit can be replaced with a pattern unit which has a same pattern as the preset pattern or a pattern unit which has a different pattern from the preset pattern.

15. A method of displaying on a printing apparatus the amount of heat corresponding to a printing state of the printing apparatus, comprising:
starting a printing process upon a command to print data;
changing a color intensity of a preset pattern on the printing apparatus to display a pattern corresponding to increasing heat;
completing a printing process wherein the printing apparatus is in a standby mode or turned off mode; and
changing the color intensity of the preset pattern on the printing apparatus to a prior pattern corresponding to decreasing heat.

16. The method of claim 15 wherein the color intensity of the preset pattern varies according to an internal temperature of the printing apparatus due to heating of a fixing unit.

17. The method according to claim 15, wherein the changing of the color intensity of the preset pattern comprises changing the color intensity of a thermochromic resin formed in a shape on an acrylonitrile butadiene styrene (ABS) resin.

18. The method according to claim 15, wherein the preset pattern is formed on a pattern unit using a thermochromic colorant.

19. The method according to claim 15, wherein the preset pattern is at least one of an image and a text.

20. The method according to claim 18, wherein the pattern unit with a preset pattern is replaceable.

21. The method according to claim 20, wherein the pattern unit with the preset pattern can be replaced with a pattern unit which has a same pattern as the preset pattern or a pattern unit which has a different pattern from the preset pattern.

22. A method of displaying a temperature of a printing apparatus, comprising:
activating a printing apparatus to print data;
indicating an amount of heat radiating from the printing apparatus; and
changing the indicating the amount of heat radiating from the printing apparatus corresponding to the changing amounts of heat radiating from the printing apparatus.

23. The method of claim 22, wherein the indicating the amount of heat comprises changing a heat indication unit on the printing apparatus to indicate an increase or a decrease in the amount of heat radiating from the printing apparatus.

24. The method of claim 23, wherein the heat indication unit comprises thermochromic resin changing a color intensity corresponding to the amount of heat radiating from the printing apparatus.

25. The method of claim 23, wherein the heat indication unit comprises at least one light emitting unit changing a light emission corresponding to the amount of heat radiating from the printing apparatus, a thermometer changing a temperature corresponding to the amount of heat radiating from the printing apparatus, or a digital display displaying at least one of a number, an image or a text changing a display corresponding to the amount of heat radiating from the printing apparatus.
